(19) United States
(12) Patent Application Publication
(10) Pub. No.: US 2025/0176595 A1
(43) Pub. Date: Jun. 5, 2025

(54) STARCH BASED WHITENING AND OPACIFYING AGENTS AND USES THEREOF

(71) Applicant: ARCHER-DANIELS-MIDLAND COMPANY, Decatur, IL (US)

(72) Inventors: Shireen Baseeth, Decatur, IL (US); Olivia Rhode, Decatur, IL (US); Ali Halalipour, Decatur, IL (US); Alyssa Davis, Decatur, IL (US)

(21) Appl. No.: 18/842,777

(22) PCT Filed: Mar. 1, 2023
(86) PCT No.: PCT/US2023/063480

§ 371 Date: Aug. 29, 2024

Related U.S. Application Data
(60) Provisional application No. 63/315,450, filed on Mar. 1, 2022.

(51) Int. Cl. A23L 5/41; A23G 3/34; A23G 4/06; A23L 29/212

(52) U.S. Cl. CPC A23L 5/41; A23G 3/343; A23G 4/062; A23L 29/212

(57) ABSTRACT

Starch based whitening and opacifying starch products and uses thereof in food products are disclosed. The starch-based whitening and opacifying starch products may be used to coat food products or be mixed with food products to whiten and opacify such food products.

### FIELD OF THE INVENTION

The present invention relates generally to opacifying or whitening agents. More particularly, the present invention relates to processes for using starch based opacifying or whitening agents, such as in confectionary compositions.

### BACKGROUND OF THE INVENTION

Titanium dioxide is a common food additive used for its whitening effects in processed foods such as baked goods, confectionaries, chewing gum, soups, and creamers. Titanium dioxide is also used for its whitening and opacifying effects in personal care products, cosmetics, and paints and coatings.

Titanium dioxide has recently been declared by the European Food Safety Authority to no longer be safe as a food additive. Accordingly, needs exist for safer whitening and opacifying agents for use in foods.

### SUMMARY OF THE INVENTION

In each of various embodiments, the present invention solves these needs and discloses starch-based whitening and opacifying agents.

In one embodiment, a process of coating a food product comprises dispersing a starch-based whitening or opacifying agent in a liquid, thus producing a coating composition, coating the food product with the coating composition, and allowing the coating composition to dry.

In another embodiment, a process of coating a food product comprises dispersing a starch particle coated with an emulsifier or a lipid in a liquid, thus producing a coating composition and coating the food product with at least one layer of the coating composition.

In a further embodiment, a process of opacifying a food product comprises mixing an effective amount of a starch-based whitening or opacifying agent with the product in an amount to provide opacity to the food product.

In an additional embodiment, a process of opacifying a food product comprises mixing an effective amount of a starch particle coated with an emulsifier or a lipid with the product in an amount to provide opacity to the food product.

In yet a further embodiment, the use of a starch particle coated with an emulsifier, a lipid, or a combination thereof in a liquid as an opacifying or whitening agent in a food product is disclosed.

### BRIEF DESCRIPTION OF THE DRAWINGS

FIG. 1 shows the whiteness (L*) for panning with various embodiments of the starch-based whitening or opacifying agents of the present invention compared to different commercially available products.

FIG. 2 shows the whiteness (L*) for panning with various embodiments of the starch-based whitening or opacifying agents of the present invention at different amounts (5 or 10%).

### DETAILED DESCRIPTION OF THE INVENTION

In one embodiment, a process of coating a food product comprises dispersing a starch-based whitening or opacifying agent in a liquid, thus producing a coating composition, coating the food product with the coating composition, and allowing the coating composition to dry. The food product may be a confection or a food particle. The confection may be a panned confection, a gum, or a pressed tablet.

The starch-based whitening or opacifying agent may be a micronized starch having a particle size range of d50 of 6-7 μm or a d90 of less than 10 μm.

The starch based whitening or opacifying agent may be produced by (a) heating a mixture of water and native or modified starch or flour to a temperature in the range of 25° Celsius to less than 200° Celsius, extruding the mixture with a screw configuration comprising in series at least one low-shear forward conveying screw and at least one high-shear mixing screw to produce an extrudate; or (b) forming a mixture of water, a lipid, and native or modified starch or flour, and drying the mixture of water, lipid, and native or modified starch or flour to produce a dried lipid starch intermediate or dried lipid flour intermediate.

In the process of coating the food product, the liquid may include a sweetener that may be a sugar-based sweetener or a sugar-free sweetener. The process may further include sealing the food product before coating the food product with the coating composition.

The process may include repeating coating the food producing with the coating composition and allowing the coating composition to dry.

In an additional embodiment, a process of coating a food product comprises dispersing a starch particle coated with an emulsifier, a lipid, or a combination thereof in a liquid, thus producing a coating composition and coating the food product with at least one layer of the coating composition.

The food product may be a confection or a food particle. The confection may be a panned confection, a gum, or a pressed tablet.

The starch particle may be a micronized starch having a particle size range of d50 of 6-7 μm or a d90 of less than 10 μm.

The liquid in the process may comprise a sweetener that may be a sugar-based sweetener or a sugar-free sweetener.

The process may further comprise sealing the food product before coating the food product with the coating composition. The process may also include repeating coating the food producing with the coating composition and allowing the coating composition to dry.

In a further embodiment, a process of opacifying a food product includes mixing an effective amount of a starch-based whitening or opacifying agent with the product in an amount to provide opacity to the food product. The food product may be selected from the group consisting of a beverage, powdered drink, a powdered mix, a baked good, a fondant, an icing, a compound coating, a topping, a dairy product, a dairy alternative product, a soup, a sauce, a dressing, a meal alternative, a ped food, a creamer, or a pet treat.

The starch-based whitening or opacifying agent may be a micronized starch having a particle size range of d50 of 6-7 μm or a d90 of less than 10 μm.

The starch based whitening or opacifying agent may also be produced by (a) heating a mixture of water and native or modified starch or flour to a temperature in the range of 25° Celsius to less than 200° Celsius, extruding the mixture with a screw configuration comprising in series at least one low-shear forward conveying screw and at least one high-shear mixing screw to produce an extrudate or (b) forming a mixture of water, a lipid, and native or modified starch or flour, and drying the mixture of water, lipid, and native or modified starch or flour to produce a dried lipid starch intermediate or dried lipid flour intermediate.

In another embodiment, a process of opacifying a food product includes mixing an effective amount of a starch particle coated with an emulsifier or a lipid with the product in an amount to provide opacity to the food product. The food product may be selected from the group consisting of a beverage, powdered drink, a powdered mix, a baked good, a fondant, an icing, a compound coating, a topping, a dairy product, a dairy alternative product, a soup, a sauce, a dressing, a meal alternative, a ped food, a creamer, or a pet treat.

The starch particle may be a micronized starch having a particle size range of d50 of 6-7 μm or a d90 of less than 10 μm. The starch particle may be coated with the lipid and the emulsifier.

In another embodiment, use of a starch particle coated with an emulsifier, a lipid, or a combination thereof in a liquid as an opacifying or whitening agent in a food product.

In one embodiment, a starch-based whitening or opacifying agent may be a milled corn starch. The milled corn starch may be a PEARLEDGE brand corn starch, such as PEARLEDGE SILK, PEARLEDGE SATIN, or PEARLEDGE SHINE, each available from Archer-Daniels-Midland Company of Decatur, Illinois. The milled corn starch may be micronized to a particle size of a d50 of 6-7 μm and/or a d90 of less than 10 μm.

In a further embodiment, the starch-based whitening or opacifying agent may be the ultra-fine starch/flour product described in International Publication No. WO 2021/119532 assigned to Archer-Daniels-Midland Company of Decatur, Illinois. Such ultra-fine starch/flour product may be produced by: heating a mixture of water and native or modified starch or flour to a temperature in the range of 25° Celsius to less than 200° Celsius, extruding the mixture with a screw configuration comprising in series at least one low-shear forward conveying screw and at least one high-shear mixing screw to produce an extrudate or forming a mixture of water, a lipid, and native or modified starch or flour, and drying the mixture of water, lipid, and native or modified starch or flour to produce a dried lipid starch intermediate or dried lipid flour intermediate.

In a further embodiment, the starch-based whitening or opacifying agent may be a milled corn starch described herein coated with a fat and/or an emulsifier.

Non-limiting examples of fats that may be used include, but are not limited to, coconut oil, coconut fatty acids, palmitic acid, vegetable oils, vegetable fatty acids, and combinations of any thereof.

Non-limiting examples of emulsifiers that may be used include, but are not limited to, monoglycerides, monodiglycerides, lecithin, and combinations of any thereof.

The invention is further described in the following non-limiting Examples.

### Example 1

Preparation of starch-based whitening or opacifying agent.

A native corn starch was milled to a particle size range of d50 of 6-7 μm and a d90 of less than 10 μm as measured with a Malvern Mastersizer 3000 dry module. A fluidized bed jet mill (Netzsch condux CGS 10) was used to make the micronized starch. The starch was introduced into the mill by a volumetric feeder and milled by compressed gas supplied at 6 bars to three grinding nozzles. The particle size may be tuned as desired by adjusting the rotational speed of an internal classifier in the jet mill.

### Example 2

The micronized starch of Example 1 was further processed by spray drying with a lipid and an emulsifier. The spray drying was done in two stages. In the first stage, the fat was melted to a temperature of at least 10° C. above the melting point of the fat, and the melted fat was blended with the emulsifier to form a homogenous mixture. The fat/emulsifier blend (at a ratio of 1:1 fat to emulsifier) was homogenized at 4000 rpm using a Silverson homogenizer for 10 minutes to form a uniform dispersion. In this Example, the emulsifier was a C8/C10 monodiglyceride (Drewmulse GMC 9-10 available from Stepan, USA). The fats used were coconut oil, coconut fatty acid and palmitic acid. The lipid/emulsifier dispersion was added to water and slurried with the micronized starch at low shear. The resulting lipid/emulsifier/starch dispersion was spray dried with an inlet temperature of 370° F. (plus/minus 5° F.), and an outlet temperature of 175° F. (plus/minus 5° F.) and sieved through a 20-mesh screen.

### Example 3

### Hard Sucrose Panning Application.

A number of different starch-based whitening or opacifying agents were used in a panning application at a 5% or 10% inclusion. The starch-based agents shown in Table 1 were used.

TABLE 1

| Samples | Description |
|---|---|
| Native Corn Starch (6-7 μm) | Micronized Starch |
| Native Corn Starch (6-7 μm) + | Micronized Starch + Monoglyceride |
| MONO | |
| Native Corn Starch (6-7 μm) + | Micronized Starch + Coconut Oil + |
| COL | Monoglyceride |
| Native Corn Starch (6-7 μm) + | Micronized Starch + Coconut Fatty |
| CFA | Acid + Monoglyceride |
| Native Corn Starch (3-4 μm) + | Micronized Starch + Palmitic Acid + |
| PFA | Monoglyceride |
| Rice Starch + MONO | Rice Starch + Monoglycerides |

Dark chocolate coated soybeans were used as a starting medium for hard panning. An engrossing syrup was made with granulated sucrose (66%) and water (33%). The starch-based whitening or opacifying agents were added to the engrossing syrups at inclusion levels of 5 or 10%. Air was used as a drying medium in this engrossing step, and no air was applied during the finishing step.

A Latini Enterprises coating pan was used for the panning process with a 16-inch stainless steel smooth pan attachment. The air and speed were adjusted as needed. The conditions of the engrossing process were about 50-60% relative humidity and a temperature of about 60-70° F. The engrossing syrups were drizzled on the chocolate-covered soybeans using a 10 mL syringe.

The chocolate-covered soybeans were pre-sealed with a gum Arabic (40%) and water (60%) solution. The pre-sealing provided a good base for the engrossing syrup to adhere. The gum Arabic solution was added to the chocolate-covered soybeans in 3 coats, at 20 mL each coat, with a dry charge of powdered sucrose added in between each coat. The pre-sealed chocolate-covered soybeans were allowed to dry overnight at room conditions.

The engrossing syrup was made by bringing granulated sucrose and water to a boil and cooking until 70% solids were achieved with a refractometer. The engrossing syrup was weighed into containers and allowed to sit overnight to completely cool. The percent of starch-based whitening or opacifying agents needed was calculated based on the amount of engrossing syrup. The starch-based whitening or opacifying agents were added and dispersed in the engrossing syrup using high shear at 2700 RPM for 2 minutes with a Silverson mixer. The engrossing syrups were allowed to completely cool, and the solids were tested and adjusted back to 70% as needed. The white syrups (containing the starch-based whitening or opacifying agents) were run on a Minolta colorimeter.

The engrossing step of the chocolate-covered soybeans with the white syrups was done in about 20 total coats (10 mL of white syrup each coat). For each coat, the chocolate covered soybeans were tumbled for about 1-2 minutes with the white syrup without air to coat the chocolate covered soybeans, then air was applied for about 1 minute to dry the white syrup and prepare for the next coating. The engrossing step was used to apply about 20 coats.

A finishing step was performed next, which was similar to the engrossing step, and was used to establish a nice, smooth finish on the chocolate covered soybeans. The finishing step was done with the white engrossing syrup diluted with water to 67% solids and added in 10 coats of 10 mL each. The finishing step was tumbled dry for about 10 minutes with no air. After finishing, the coated soybeans were allowed to dry overnight.

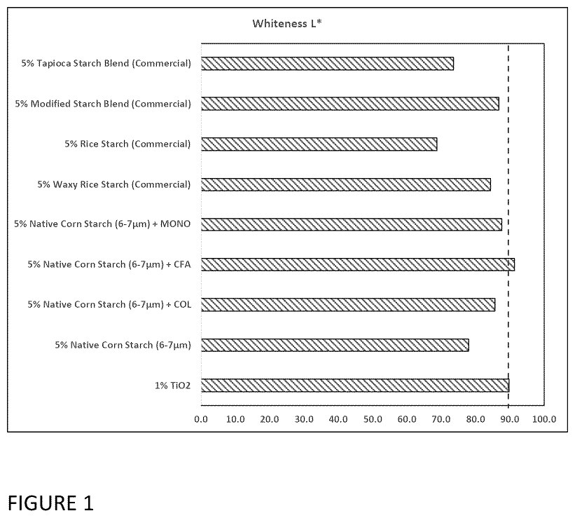

FIG. 1 shows the whiteness (L*) for panning with the different starch-based whitening or opacifying agents of the present invention compared to different commercially available products.

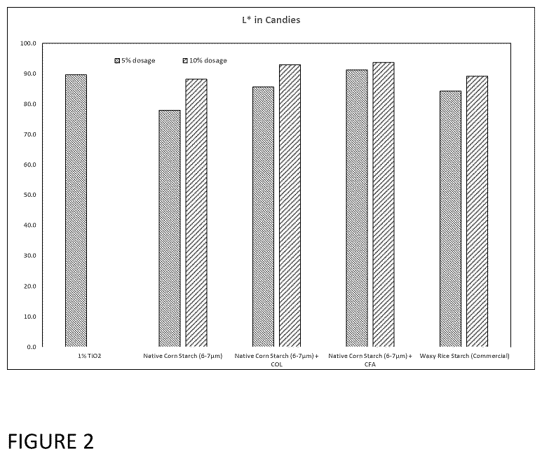

FIG. 2 shows the whiteness (L*) for panning for the different starch-based whitening or opacifying agents of the present invention at different amounts (5 or 10%). 5% is the darker bar and 10% is the lighter bar.

This disclosure has been described with reference to certain exemplary embodiments, compositions, and uses thereof. However, it will be recognized by those of ordinary skill in the art that various substitutions, modifications, or combinations of any of the exemplary embodiments may be made without departing from the spirit and scope of the disclosure. Thus, the disclosure is not limited by the description of the exemplary embodiments, but rather by the appended claims as originally filed.

1. A process of coating a food product comprising:
dispersing a starch-based whitening or opacifying agent in a liquid, thus producing a coating composition;
coating the food product with the coating composition; and
allowing the coating composition to dry.

2. The process of claim 1, wherein the food product is a confection or a food particle.

3. The process of claim 2, wherein the confection is a panned confection, a gum, or a pressed tablet.

4. The process of claim 1, wherein the starch-based whitening or opacifying agent is a micronized starch.

5. The process of claim 4, wherein the micronized starch has particle size range of d50 of 6-7 μm or a d90 of less than 10 μm.

6. The process of claim 1, wherein the starch-based whitening or opacifying agent is produced by:
(a) heating a mixture of water and native or modified starch or flour to a temperature in the range of 25° Celsius to less than 200° Celsius, extruding the mixture with a screw configuration comprising in series at least one low-shear forward conveying screw and at least one high-shear mixing screw to produce an extrudate; or
(b) forming a mixture of water, a lipid, and native or modified starch or flour, and drying the mixture of water, lipid, and native or modified starch or flour to produce a dried lipid starch intermediate or dried lipid flour intermediate.

7. The process of claim 1, wherein the liquid comprises a sweetener.

8. (canceled)

9. The process of claim 1, further comprising sealing the food product before coating the food product with the coating composition.

10. The process of claim 1, further comprising repeating coating the food producing with the coating composition and allowing the coating composition to dry.

11. A process of coating a food product comprising:
dispersing a starch particle coated with an emulsifier, a lipid, or a combination thereof in a liquid, thus producing a coating composition; and
coating the food product with at least one layer of the coating composition.

12. The process of claim 11, wherein the food product is a confection or a food particle.

13. (canceled)

14. The process of claim 1, wherein the starch particle is a micronized starch.

15. The process of claim 14, wherein the micronized starch has particle size range of d50 of 6-7 μm or a d90 of less than 10 μm.

16. The process of claim 11, wherein the liquid comprises a sugar-based or a sugar-free sweetener.

17. (canceled)

18. The process of claim 11, further comprising sealing the food product before coating the food product with the coating composition.

19. The process of claim 11, further comprising repeating coating the food producing with the coating composition and allowing the coating composition to dry.

20. A process of opacifying a food product, comprising:
mixing an effective amount of a starch-based whitening or opacifying agent with the product in an amount to provide opacity to the food product.

21. The process of claim 20, wherein the food product is selected from the group consisting of a beverage, powdered drink, a powdered mix, a baked good, a fondant, an icing, a compound coating, a topping, a dairy product, a dairy alternative product, a soup, a sauce, a dressing, a meal alternative, a ped food, a creamer, or a pet treat.

22. The process of claim 20, wherein the starch-based whitening or opacifying agent is a micronized starch having a particle size range of d50 of 6-7 μm or a d90 of less than 10 μm.

23. (canceled)

24. The process of claim 20, wherein the starch-based whitening or opacifying agent is produced by:
(a) heating a mixture of water and native or modified starch or flour to a temperature in the range of 25° Celsius to less than 200° Celsius, extruding the mixture with a screw configuration comprising in series at least one low-shear forward conveying screw and at least one high-shear mixing screw to produce an extrudate; or
(b) forming a mixture of water, a lipid, and native or modified starch or flour, and drying the mixture of water, lipid, and native or modified starch or flour to produce a dried lipid starch intermediate or dried lipid flour intermediate.

25-30. (canceled)
